(19) United States
(12) Patent Application Publication
(10) Pub. No.: US 2026/0154247 A1
(43) Pub. Date: Jun. 4, 2026

(54) DATA TRANSFER IN A COMPUTER-IMPLEMENTED DATABASE FROM A DATABASE EXTENSION LAYER

(71) Applicant: SAP SE, Walldorf (DE)

(72) Inventors: Michael Muehle, Walldorf (DE); Amit Sankhla, Pune (IN); Oleg Skoromnik, Gaiberg (DE); Johannes Beigel, Rauenberg (DE)

(21) Appl. No.: 18/968,217

(22) Filed: Dec. 4, 2024

(51) Int. Cl. G06F 16/21; G06F 16/25

(52) U.S. Cl. CPC G06F 16/219; G06F 16/25

(57) ABSTRACT

In some embodiments, there may be provided extracting, from a redo log, a first chunk of data; checking whether a population indicator is set; in response to the first chunk of data, creating a main buffer; in response to a population indicator not set, writing the first chunk of data to the created main buffer and repeat the writing for one or more additional chunks until a last chunk is extracted; and after the last chunk is written to the main buffer, reading the main buffer to write the first chunk of data, the one or more additional chunks, and the last chunk to main memory. Related systems, methods, and articles of manufacture are also disclosed.

### TECHNICAL FIELD

The present disclosure generally relates to database processing.

### BACKGROUND

A database is an organized collection of data. A database typically organizes data to correspond to how the data is logically arranged. This facilitates operations on the data, for example, looking up values in a database, adding data to the database, sorting the data in the database, or summarizing relevant data in the database. A database management system (“DBMS”, or “database system,” for short) mediates interactions between a database, users, and applications to organize, create, update, capture, analyze, and otherwise manage the data in the database. In order to efficiently handle queries, databases are typically configured to perform in-memory operations on data. In an in-memory database for example, the data needed to execute and respond to a query is loaded into memory, and the query is executed against that in-memory data.

### SUMMARY

Systems, methods, and articles of manufacture, including computer program products, are provided for data transfers as part of redo log processing. In some embodiments, there may be provided extracting, from a redo log, a first chunk of data; checking whether a population indicator is set; in response to the first chunk of data, creating a main buffer; in response to a population indicator not set, writing the first chunk of data to the created main buffer and repeat the writing for one or more additional chunks until a last chunk is extracted; and after the last chunk is written to the main buffer, reading the main buffer to write the first chunk of data, the one or more additional chunks, and the last chunk to main memory.

In some variations, one or more features disclosed herein including the following features can optionally be included in any feasible combination. For example, in response to writing the last chunk to the main memory, the main memory may be marked as populated. And, in response to writing the last chunk to the main memory, the created main buffer may be destroyed. Moreover, at least one chunk of delta data corresponding to a portion of the redo buffer obtained from a delta memory of a database management system may be written. And, the checking may include checking the main memory of a database management system for the population indicator.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1A depicts an example of a delta fragment of a column store database and a main fragment of the column store database, according to some implementations of the current subject matter;

FIG. 1B depicts an example of a system including a database, according to some implementations of the current subject matter;

FIG. 2 depicts an example of a process for redo logging, according to some implementations of the current subject matter;

FIG. 3 depicts an example of a process for redo processing, according to some implementations of the current subject matter;

FIG. 4 depicts another example of a system, according to some implementations of the current subject matter;

FIG. 5 depicts another example of a system, according to some implementations of the current subject matter; and

FIG. 6 depicts another example of a process, according to some implementations of the current subject matter.

### DETAILED DESCRIPTION

Database management systems, such as in-memory databases, column store databases, and/or other types of database management systems, may perform redo logging. The redo log may be one or more files that associated with (e.g., internal to) the database management system. The redo log may be stored in a data structure so that it can be accessed by the database management system (or, e.g., database system, for short). During a restart or a restore of the database system, the redo log file(s) are used by the database system during a restart or a restore. The redo log files may include redo log entries for some if not all of the database transactions, such as the transactions causing changes to data, such as attributes, that were not committed or completed before the last savepoint, so the database system needs to repeat those transactions in order to have restore the data to an accurate state.

In an in-memory database system for example, the data used to perform the database transaction are stored primarily in memory to provide optimal performance, but persistent storage may be used as well to for example store certain data, such as data used to provide a fallback caused by a fault, a failure, or some other reason. In the case of the in-memory database system, certain data, such as change data, may be saved from time to time from memory (i.e., “in-memory”) to persistent storage. The term “savepoints” refers to the instances when these saves occur. The savepoints may be set to occur every 5 minutes, for example (although other times may be used) to save changes to the data made by database operations during database transactions. When there is a failure of the database system, a redo processing manager may access the redo log, which includes the data changes occurring after the last savepoint (which as a result were not committed or completed). In the case of the in-memory database, the redo processing manager may use the redo logs to restore the data in-memory to the state before the failure occurred.

In some embodiments, there are provided processes for redo logging and redo processing of the redo log. Before providing examples of the redo logging process and redo processing, the following provides a description of an example system environment, delta fragments, load formats, and the like.

With respect to the in-memory database system, the in-memory database system may be configured as a column-oriented database. The column store database stores data in columns instead of rows, such that the columnar stored data can improve the efficiency of data retrieval and analysis. Although some of the examples refer to an in-memory, column store database (an example of which is SAP HANA), other types of database systems may be used as well.

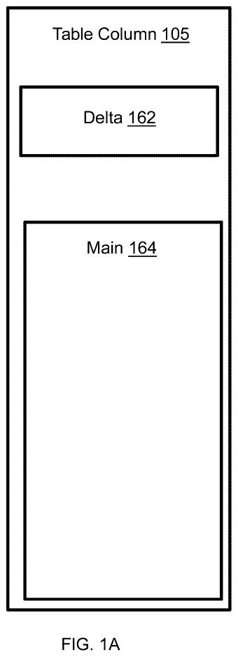

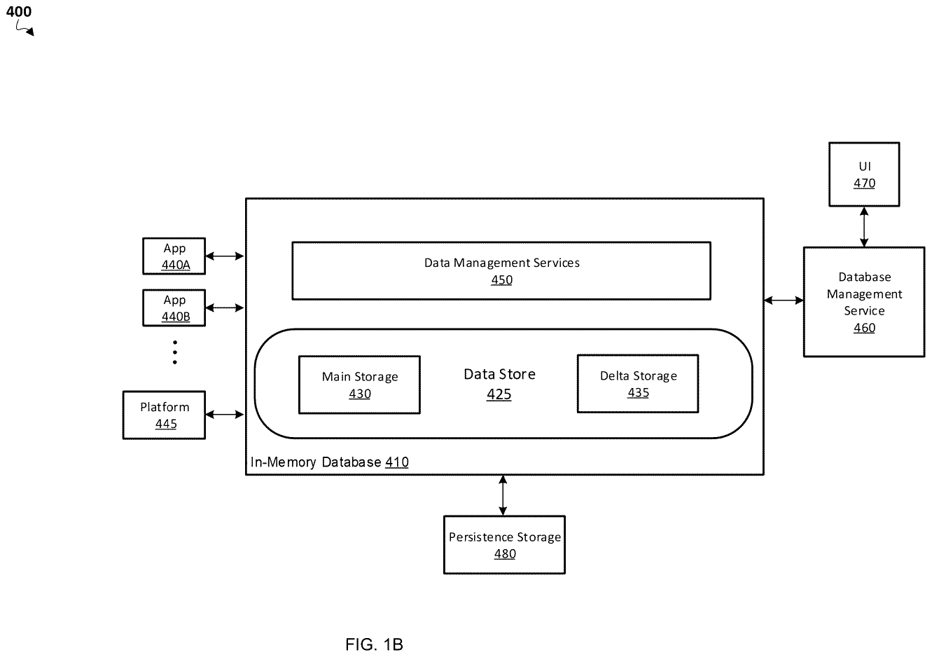

FIG. 1A depicts an example of a delta fragment 162 of a column store database and a main fragment 164 of the column store database, both of which are associated with a database table, which is a table column 105. The column store's main fragment 164 may include most if not all of the data of the table column 105 (or, if partitioned, of that columnar partition), and the delta fragment 162 contains newly-written data that has not yet been merged into the column store's main fragment 164. Although only a single column, delta fragment, and main fragment are shown to simplify the explanation, the column-oriented database may include additional fragments and columns.

When bringing data from persistence storage locations to in-memory locations, the database system may bring the data into memory using a variety of formats. For example, one format used is referred to as a column-loadable format. For the column-loadable format, the entire column of a column store database is fully loaded into memory to enable a database operation on the column. Fully loading the entire column into memory means bringing the entirety of the column's data, dictionary, and index into memory. Another type of format that can be used referred to as a page-loadable format. For the page-loadable format, only the pages that contain the part(s) of the column relevant to the database operation (such as a query) are loaded into memory. Although some of the examples refer to a page-loadable and column-loadable formats, other types of formats may be used as well.

Referring again to redo logging, one or more savepoints may be blocked while the redo logging is being performed. As such, the data being logged may be broken up into a plurality of chunks of data to reduce the likelihood of a savepoint being blocked. Moreover, redo logging and redo processing may be configured to use the same or similar processing regardless of whether page-loadable or column-loadable data is being handled by the redo logging and/or redo processing. Further, the redo processing should write to main once rather than repeatedly. To illustrate further, the main may only be written as a single complete transaction or piece. In the case of chunking (wherein the main is written to) for each chunk, the complete main would be written to multiple time while the main grows (e.g., in size) with each chunk being added. This may result in an exponential growth of the overall written amount of data when applying to main the chunks. As data rate is limited, this results in a very large runtime of such redo execution.

FIG. 1B depicts an example of a system 400, in accordance with some embodiments. The system 400 may include one or more applications 440A-B that interact with an in-memory database 410. The applications 440A-B are representative of any number and type of applications executing within system 400. For example, the applications 440A-B may include analytical services, transaction processing service, reporting services, dashboard services, and the like. The applications 440A-B may interact with the in-memory database 410 using structure queries or other expressions.

The system 400 may also include one or more platforms 445. For example, a platform 245 may comprise a data warehousing service that exposes online analysis processing (OLAP) and/or analytical services to a user or application.

The system 400 may also include a database management services 450 and/or data management service 460 that provides administration services and access to settings of the in-memory database 410. The user interface (UI) 470 may be used to mediate interactions between the database management service 460 and a user or an application, for example, to configure the in-memory database 410 or set user preferences for sort operations.

Within the in-memory database 410, the data management service 450 may manage transactions with the main storage 430 and the delta storage 435. The data management services may provide a calculation and planning engine, modeling services, real-time replication services, data integration services, redo logging, redo processing (e.g., a redo manager), cause savepoints, and/or other services.

In the example of FIG. 1B, the main storage 430 comprises “memory” that enables fast read access to data of the in-memory database 410 in the data store 425. A read operation may access both the main storage 430 and the delta storage 435, which includes any recently changed data that has not yet been incorporated into the main storage 430.

The data in the main storage 430 may be backed up to the persistence storage 480 (e.g., from time to time, such as in response to a savepoint). The persistence storage 480 may be disk storage or other suitable type of storage device. The change data in the delta storage 435 may also be backed up to the persistence storage 480 (e.g., from time to time, such as in response to a savepoint), so that changes survive events such as database failures, downtimes, and so on. Moreover, the persistence storage 480 may store data as a database object in a persistence format, such as page-loadable, column-loadable format, or other formats as well. It should be understood that the example architecture of system 400 is merely indicative of what may be employed in some embodiments as the system 400 may be structured in other suitable manners with other arrangements of components as well.

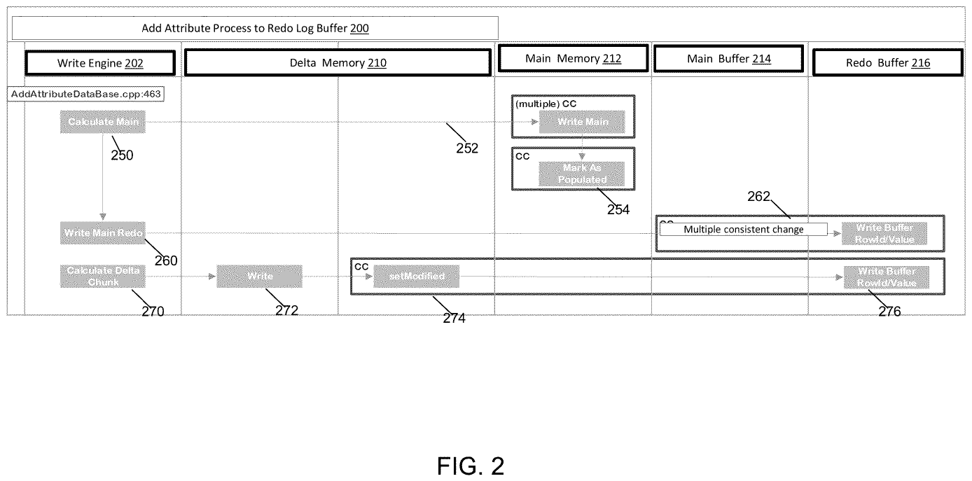

FIG. 2 depicts an example process 200 for redo logging, in accordance with some embodiments.

In the example of FIG. 2, the redo logging is in the context of adding or changing data (e.g., an attribute) that is associated with the in-memory data of the database system. For example, the database system, such as the database management service 460, may include a write engine 202 configured to write to main memory 212 (e.g., main storage 430). The database system may include an element configured to write to a delta memory 210 (e.g., delta storage 435). The main buffer 214 and redo buffer 216 each comprises a memory buffer including storage locations that store the data being logged and later accessed as part of redo processing. As database transactions occur, the main memory 212 and the delta memory 210 may include data that undergo changes that have not been persisted because a savepoint has not occurred to store these changes to persistence (e.g., persistence storage 480).

The main buffer 214 may have a separate persistence associated with it, to handle restart (or crash) after some redo chunks are already processed. To ensure data for processed redo chunks is not lost after restart and redo processing can start from next unprocessed redo chunks.

At 250, the write engine 202 writes, at 252, to main memory data (in the form of for example chunks of data). The data being written at 252 may, as noted, be the database system's data being operated on by one or more database operations. And, these changes may be written to main memory 212 as multiple consistent chunks (CC), which refers to a plurality of chunks written to main memory rather than as one big chunk. The “consistent” refers to a “lock” used to ensure consistency during the write.

The write engine 202 also marks at 254 in memory a population bit, which indicates that the main memory data has been saved or flushed to persistence (e.g., saved in response to a savepoint). In other words, the main memory is marked as populated.

At 260, the write engine 202 writes to the redo buffer 216. For example, all data that was written in 252 is also written to the redo buffer 216. In the example, multiple consistent changes (e.g., chunks of data) are written to the redo buffer.

At 270, the write engine 202 may also determine (e.g., calculate) the delta. For example, the write engine 202 may determine what data should be written to the delta memory 274 and may write at 272 the data to the delta memory 210. In the example of FIG. 2, the write to delta memory 210 in in the form of multiple consistent changes (e.g., chunks of data stored as a “consistent change,” which refers to the writing being performed with a “lock” in place).

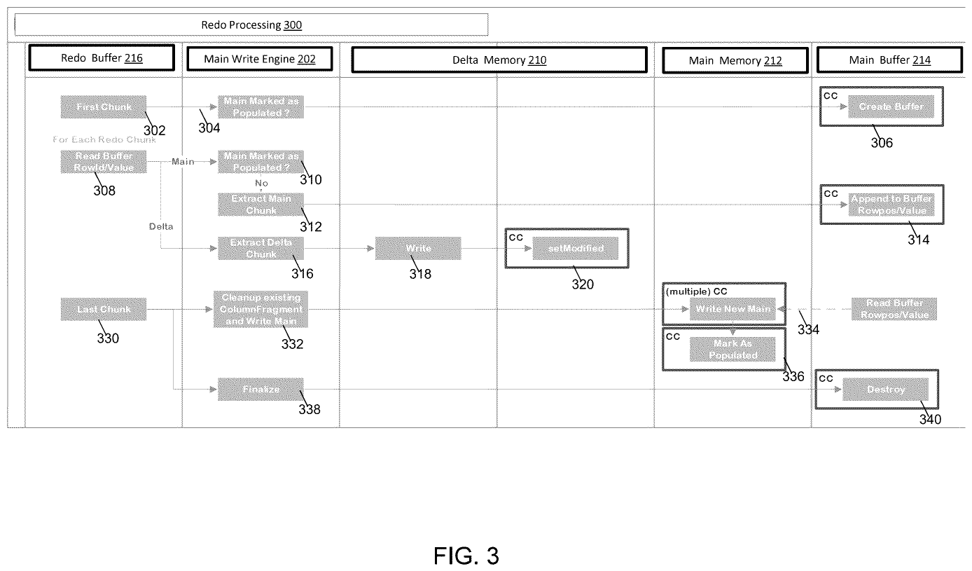

FIG. 3 depicts an example of a process 300 for redo processing using the redo logs stored in a main buffer 214, in accordance with some embodiments.

At 302, the database management system, such as in-memory database 410, may include a redo processor that first obtains a first chunk of data from the redo buffer 216 (which as noted with respect to FIG. 2 includes the redo logging files). The first chunk extracted from the redo buffer is provided at 304 to the write engine 202, which causes at 306 the creation of a buffer at the main buffer 214. buffer

At 304, the write engine 202 may check to see if the extracted first chunk has a population indicator set. The check may not be performed on extracted data of a first chunk but rather on an existing main persistence that holds a population bit indicator. For example. the check is performed when the first redo chunk is processed to decide whether there is a need to populate the main buffer 214 (e.g., if the population bit is set, there is no need to populate main memory using a redo chunk so no need for main buffer). To illustrate further, the population bit indicator may indicate (e.g., when set to “1” or “true”) that the extracted chunk has already been persisted (e.g., due to a savepoint) to persistent storage (e.g., persistence storage 480), so there is no need to repopulate the data using the redo logged data. However, if the population indicator is not set (e.g., when set to “0”, not true, not present, etc.) that extracted chunk has not been persisted since the last savepoint to persistent storage (e.g., persistence storage 480), so there is a need to for the redo processor to repopulate data using the redo processing and the redo logged data.

At 308, the database management system (or the redo processor) may, for each chunk of data from the redo buffer 216, read the data for a chunk (e.g., based on row identifier and/or value). In the case of the data corresponding to redo data associated with main memory (e.g., main storage 430), a check is performed at 310 to see if the population indicator is set. If the population indicator is not set, the extracted chunk is, at 312, written at 314 to the main buffer 214. The extracted chunk may be provided as one or more consistent chunks and appended to the main buffer 214 (e.g., using row ID and value). For each chunk extracted from the redo buffer, 310-314 is repeated to provide the main buffer 214 the change data for the main memory.

In the case of the data corresponding to redo data is associated with delta memory (e.g., delta storage 435), the extracted chunk is, at 316, written by the write engine 202 directly to delta memory 210 using one or more chunks, such as the one or more consistent chunks.

In the case of the data corresponding to redo data associated with main memory (e.g., main storage 430), the chunks of data may include an indicator of a first chunk and/or a last chunk. As such, when a last chunk of data is detected in the redo buffer, this indicates to the write engine 202 that the data in main memory can be repopulated using the main buffer 214. To illustrate, the main memory 212 may include the persistently stored data (which was stored at the last savepoint), while main buffer 214 redo data includes data that changed since the last savepoint. As such, the main buffer 214 redo data “repopulates” the main memory 212 data so that the main memory reflects all the changes that occurred after the savepoint.

At 334, the main buffer 214 is read and written into the main memory 212. When the reads from the main buffer 214 are completed (e.g., all the chunks have been read), the population indicator is marked as “set” to indicate the main memory 212 has been populated and main buffer is not required any more. In response, the write engine 202 may destroy (e.g., delete, flush, free up, etc.) the main buffer 214 as the process 300 is complete.

In some embodiments, the main buffer 214 comprises a page chain of logically connected pages in memory. This page chain may be created when the redo chunk marked as first at 302 is executed.

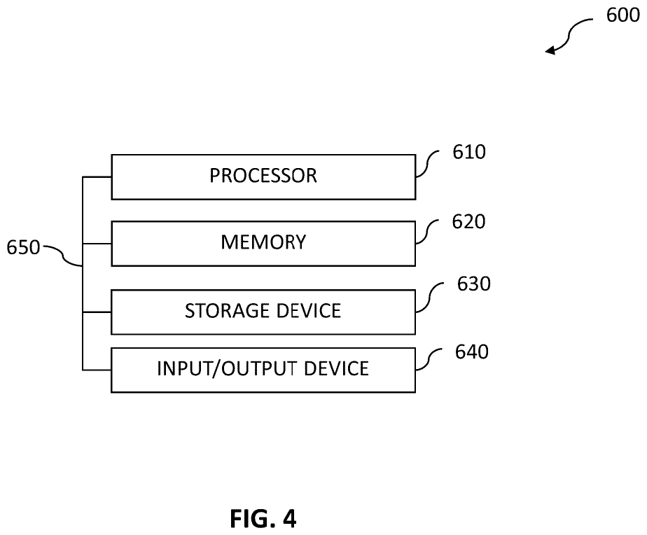

In some implementations, the current subject matter may be configured to be implemented in a system 600, as shown in FIG. 4. The system 600 may include a processor 610, a memory 620, a storage device 630, and an input/output device 640. Each of the components may be interconnected using a system bus 650. The processor 610 may be configured to process instructions for execution within the system 600. In some implementations, the processor 610 may be a single-threaded processor. In alternate implementations, the processor 610 may be a multi-threaded processor. The processor 610 may be further configured to process instructions stored in the memory 620 or on the storage device 630, including receiving or sending information through the input/output device 640. The processor 610 may be further configured to execute the processes described with reference to FIGS. 2, 3, and/or 6. The memory 620 may store information within the system 600. In some implementations, the memory 620 may be a computer-readable medium. In alternate implementations, the memory 620 may be a volatile memory unit. In yet some implementations, the memory 620 may be a non-volatile memory unit. The storage device 630 may be capable of providing mass storage for the system 600. In some implementations, the storage device 630 may be a computer-readable medium. In alternate implementations, the storage device 630 may be a floppy disk device, a hard disk device, an optical disk device, a tape device, non-volatile solid state memory, or any other type of storage device. The input/output device 640 may be configured to provide input/output operations for the system 600. In some implementations, the input/output device 640 may include a keyboard and/or pointing device. In alternate implementations, the input/output device 640 may include a display unit for displaying graphical user interfaces.

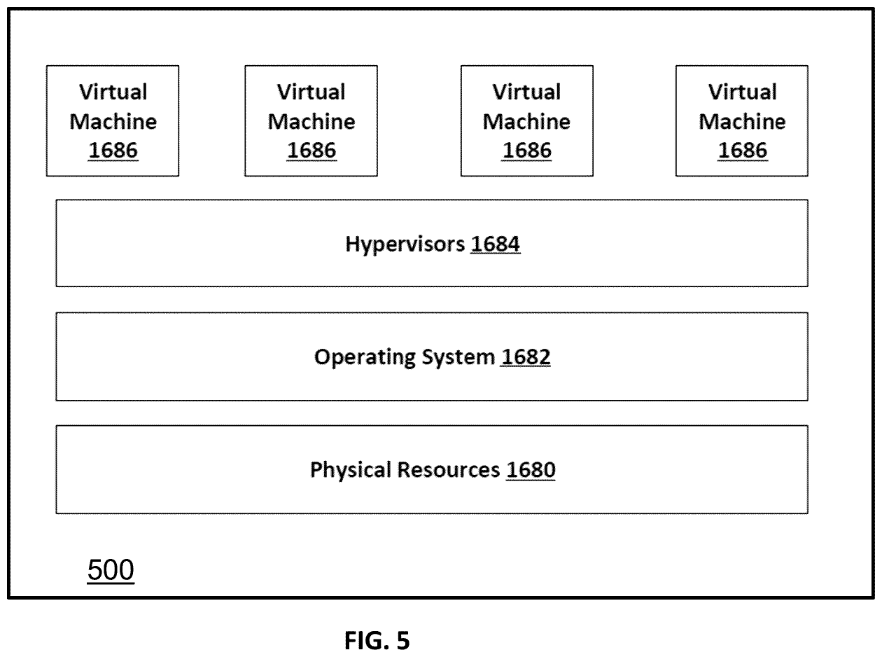

FIG. 5 depicts an example implementation of the system 500. The system 500 may comprise one or more of the components of FIGS. 1B, 2, and/or 3 For example, the in-memory database 410, applications, persistent storage, and/or the like may be implemented using the virtual machines to provide a cloud-based implementation.

The system 500 may be implemented using various physical resources 1680, such as at least one or more hardware servers, at least one storage, at least one memory, at least one network interface, and the like. The system 100 may also be implemented using infrastructure, as noted above, which may include at least one operating system 1682 for the various physical resources 1680 and at least one hypervisor 1684 (which may create and run at least one virtual machine 1686). For example, each multitenant application may be run on a corresponding at least one virtual machine 1686.

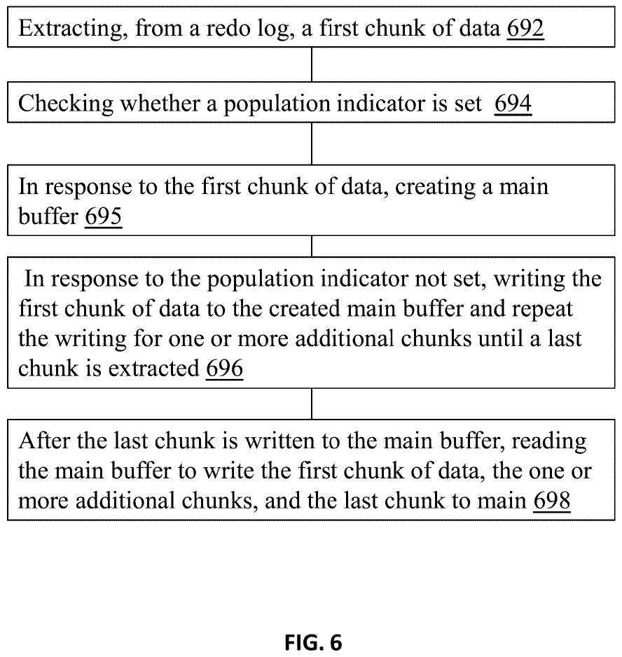

FIG. 6 depicts an example of a process for redo processing, in accordance with some embodiments.

At 692, the process may include extracting, from a redo log, a first chunk of data, in accordance with some embodiments. Referring to FIG. 3 at 302 for example, a first chunk (a portion of the data but not the entire amount of data) may be extracted from a redo log stored in a redo buffer 216.

At 694, the process may include checking whether a population indicator is set, in accordance with some embodiments. Referring to FIG. 3 at 310 for example, a population bit is checked. This population indicator may be set in for example main memory 212.

At 695, the process may include in response to the first chunk of data, creating a main buffer, in accordance with some embodiments. Referring to FIG. 3 at 306 for example, a main buffer 214 may be created. As noted, if population bit is set in main memory, the main buffer is not created, so in some implementations, the population bit is checked before creation.

At 696, the process may include in response to the population indicator not set, writing the first chunk of data to the created main buffer and repeat the writing for one or more additional chunks until a last chunk is extracted, in accordance with some embodiments. Referring to FIG. 3 at 314 for example, the write engine 202 may write the first chunk of data to the created main buffer 214 and repeat the writing for one or more additional chunks until a last chunk is extracted and written to the main buffer 214.

At 698, the process may after the last chunk is written to the main buffer, reading the main buffer to write the first chunk of data, the one or more additional chunks, and the last chunk to main memory, in accordance with some embodiments. Referring to FIG. 3 at 334 for example, after the last chunk is written to the main buffer 214, the main buffer 214 may write the first chunk of data, the one or more additional chunks to the main memory 212. This may be performed as a single consistent chunk writing (or transaction).

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application.

### Example 1: A Computer-Implemented Method Comprising

extracting, from a redo log, a first chunk of data;
checking whether a population indicator is set;
in response to the first chunk of data, creating a main buffer;
in response to a population indicator not set, writing the first chunk of data to the created main buffer and repeat the writing for one or more additional chunks until a last chunk is extracted; and
after the last chunk is written to the main buffer, reading the main buffer to write the first chunk of data, the one or more additional chunks, and the last chunk to main memory.

### Example 2: The Computer-Implemented Method of Example 1, Further Comprising

in response to writing the last chunk to the main memory, marking, as populated, the main memory.

### Example 3: The Computer-Implemented Method of Any of Examples 1-2, Further Comprising

in response to writing the last chunk to the main memory, destroying the created main buffer.

### Example 4: The Computer-Implemented Method of Any of Examples 1-3, Comprising

writing at least one chunk of delta data corresponding to a portion of the redo buffer obtained from a delta memory of a database management system.

### Example 5: The Computer-Implemented Method of any of Examples 1-4, Wherein the Checking Comprises Checking the Main Memory of a Database Management System for the Population Indicator

### Example 6: A System Comprising

at least one processor; and
at least one memory including instructions which when executed by the at least one processor causes operations comprising:
extracting, from a redo log, a first chunk of data;
checking whether a population indicator is set;
in response to the first chunk of data, creating a main buffer;
in response to a population indicator not set, writing the first chunk of data to the created main buffer and repeat the writing for one or more additional chunks until a last chunk is extracted; and
after the last chunk is written to the main buffer, reading the main buffer to write the first chunk of data, the one or more additional chunks, and the last chunk to main memory.

### Example 7: The System of Example 6, Further Comprising

in response to writing the last chunk to the main memory, marking, as populated, the main memory.

### Example 8: The System of any of Examples 6-7, Further Comprising

in response to writing the last chunk to the main memory, destroying the created main buffer.

### Example 9: The System of any of Examples 6-8, Further Comprising

writing at least one chunk of delta data corresponding to a portion of the redo buffer obtained from a delta memory of a database management system.

### Example 10: The System of Any of Examples 6-9, Wherein the Checking Comprises Checking the Main Memory of a Database Management System for the Population Indicator.

### Example 11: A Non-Transitory Computer-Readable Storage Including Instructions Which When Executed by at Least One Processor Causes Operations Comprising

extracting, from a redo log, a first chunk of data;
checking whether a population indicator is set;
in response to the first chunk of data, creating a main buffer;
in response to a population indicator not set, writing the first chunk of data to the created main buffer and repeat the writing for one or more additional chunks until a last chunk is extracted; and
after the last chunk is written to the main buffer, reading the main buffer to write the first chunk of data, the one or more additional chunks, and the last chunk to main memory.

### Example 12: The Non-Transitory Computer-Readable Storage of Example 11, Further Comprising:

in response to writing the last chunk to the main memory, marking, as populated, the main memory.

### Example 13: The Non-Transitory Computer-Readable Storage of Any of Examples 11-12, Further Comprising:

in response to writing the last chunk to the main memory, destroying the created main buffer.

### Example 14: The Non-Transitory Computer-Readable Storage of Any of Examples 11-13, Further Comprising:

writing at least one chunk of delta data corresponding to a portion of the redo buffer obtained from a delta memory of a database management system.

### Example 15: The Non-Transitory Computer-Readable Storage of Any of Examples 14-15, Wherein the Checking Comprises Checking the Main Memory of a Database Management System for the Population Indicator

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

1. A computer-implemented method comprising:
extracting, from a redo log, a first chunk of data;
accessing a main memory of a database management system to detect whether a population bit is set in the main memory;
in response to the population bit not being set in the main memory, creating a main buffer comprising a memory buffer accessible by the database management system;
writing the first chunk of data to the created main buffer and repeating the writing for one or more additional chunks until a last chunk is extracted; and
after the last chunk is written to the main buffer, reading the main buffer to write the first chunk of data, the one or more additional chunks, and the last chunk to the main memory.

2. The computer-implemented method of claim 1, further comprising:
in response to writing the last chunk to the main memory, marking, as populated, the main memory.

3. The computer-implemented method of claim 2, further comprising:
in response to writing the last chunk to the main memory, destroying the created main buffer.

4. The computer-implemented method of claim 1, comprising:
writing at least one chunk of delta data to the main buffer. the at least one chunk of delta data corresponding to a portion of a redo buffer obtained from a delta memory of the database management system.

5. The computer-implemented method of claim 1, wherein, in response to the population bit being set in the main memory, the main buffer is not created.

6. A system comprising:
at least one processor; and
at least one memory including instructions which when executed by the at least one processor causes operations comprising:
extracting, from a redo log, a first chunk of data;
accessing a main memory of a database management system to detect whether a population bit is set in the main memory;
in response to the population bit not being set in the main memory, creating a main buffer comprising a memory buffer accessible by the database management system;
writing the first chunk of data to the created main buffer and repeating the writing for one or more additional chunks until a last chunk is extracted; and
after the last chunk is written to the main buffer, reading the main buffer to write the first chunk of data, the one or more additional chunks, and the last chunk to the main memory.

7. The system of claim 6, further comprising:
in response to writing the last chunk to the main memory, marking, as populated, the main memory.

8. The system of claim 7, further comprising:
in response to writing the last chunk to the main memory, destroying the created main buffer.

9. The system of claim 6, further comprising:
writing at least one chunk of delta data to the main buffer, the at least one chunk of delta data corresponding to a portion of a redo buffer obtained from a delta memory of the database management system.

10. The system of claim 6, wherein, in response to the population bit being set in the main memory, the main buffer is not created.

11. A non-transitory computer-readable storage including instructions which when executed by at least one processor causes operations comprising:
extracting, from a redo log, a first chunk of data;
accessing a main memory of a database management system to detect whether a population bit is set in the main memory;
in response to the population bit not being set in the main memory creating a main buffer comprising a memory buffer accessible by the database management system;
writing the first chunk of data to the created main buffer and repeating the writing for one or more additional chunks until a last chunk is extracted; and
after the last chunk is written to the main buffer, reading the main buffer to write the first chunk of data, the one or more additional chunks, and the last chunk to the main memory.

12. The non-transitory computer-readable storage of claim 11, further comprising:
in response to writing the last chunk to the main memory, marking, as populated, the main memory.

13. The non-transitory computer-readable storage of claim 12, further comprising:
in response to writing the last chunk to the main memory, destroying the created main buffer.

14. The non-transitory computer-readable storage of claim 11, further comprising:
writing at least one chunk of delta data to the main buffer, the at least one chunk of delta data corresponding to a portion of a redo buffer obtained from a delta memory of the database management system.

15. The non-transitory computer-readable storage of claim 11, wherein, in response to the population bit being set in the main memory, the main buffer is not created.

16. The computer-implemented method of claim 1, wherein the population bit indicates whether data has been saved in the main memory or flushed from the main memory for persistent storage.
